(19) United States
(12) Patent Application Publication
(10) Pub. No.: US 2010/0203751 A1
(43) Pub. Date: Aug. 12, 2010

(54) SOCKET STRUCTURE

(76) Inventor: Chou Hsien Tsai, SinJhuang City (TW)

Correspondence Address: PRO-TECHTOR INTERNATIONAL SERVICES, 20775 NORADA CT., SARATOGA, CA, 95070, US

(21) Appl. No.: 12/702,324

(22) Filed: Feb. 9, 2010

(30) Foreign Application Priority Data
Feb. 10, 2009 (TW) 098104250
Apr. 15, 2009 (TW) 098112572
Jun. 1, 2009 (TW) 098209605

(51) Int. Cl. H01R 27/00; H01R 24/00

(52) U.S. Cl. 439/222; 439/660

(57) ABSTRACT

A socket structure includes a plastic base, a connection slot, a circuit board and pin terminals. The connection slot may be engaged with an inserted plug. The circuit board positioned in the plastic base and located in the connection slot has many first traces. Each first trace has a first contact on one surface of a front section of the circuit board, and a second contact on a rear section of the circuit board. The first contacts are electrically connected to the plug. The pin terminals are electrically connected to the second contacts of the first traces. One end of each of the pin terminals extends out of the plastic base.

### BACKGROUND OF THE INVENTION

1. Field of the Invention

The invention relates to an electrical connector, and more particularly to a socket structure.

2. Related Art

At present, the most-popularized signal transmission specification in the computer is the universal serial bus (USB). A connector socket and a transmission cable satisfying this specification enable a peripheral apparatus, such as a mouse, a keyboard or the like, which is externally connected the computer, to be plugged and played immediately.

In order to satisfy the requirement of the high-flow data transmission, another plug-and-play transmission specification, such as External Serial Advanced Technology Attachment (eSATA), has been proposed. This specification has the transmission amount greater than that of USB.

The USB interface is not compatible with the eSATA interface. Although the two kinds of sockets are similar to each other, they cannot be shared.

Referring to FIG. 1, a conventional signal cable connector includes a plastic base 10, four first terminals 20, seven second terminals 25 and one metal casing 30.

The plastic base 10 has a USB connector socket 11 and an eSATA connector socket 15. A tongue 12 is disposed in the USB connector socket 11, while a tongue 16 is disposed in the eSATA connector socket 15.

The first terminal 20 is fixed to the plastic base 10 and has a vertically elastically movable contact 21 and a pin 22. The contact 21 is disposed in the USB connector socket 11 and projects downwardly from the tongue 12. The pin 22 extends downwardly from the plastic base 10 and is thus connected to a circuit board 35.

The second terminal 25 is fixed to the plastic base 10 and has a pin 27 and a contact 26, which cannot be moved elastically. The contact 26 is disposed in the eSATA connector socket 15 and projects upwardly from the tongue 16, and the pin 27 extends downwardly from the plastic base 10 and is thus connected to the circuit board 35.

The metal casing 30 covers the peripheral surfaces and the top surface of the plastic base and has one surface formed with openings 31 and 32 from which the USB connector socket 11 and the eSATA connector socket 15 are exposed.

Referring to FIG. 2, a rectangular USB plug 40 has a plastic body 41, an external iron casing 42 and four terminal connection points 43. After the external iron casing 42 covers the plastic body 41, a chamber 44 is formed inside the external iron casing 42. The hatched region represents the plastic body 41, and the four terminal connection points 43 do not have the elasticity and are exposed to the chamber 44. Please also refer to FIG. 1. The chamber 44 of the USB plug 40 corresponds to the inserted tongue 12 of the USB connector socket 11 so that the electrical connection can be created. At this time, the terminal connection points 43 are in elastic contact with the contacts 21 of the first terminals 20.

As shown in FIG. 3, a rectangular eSATA plug 45 has two slightly projecting sides and includes a plastic body 46, an external iron casing 47 and seven terminal connection points 48. The middle of the plastic body 46 is formed with a chamber 49. The hatched region represents the plastic body 46. The seven terminal connection points 48 can be moved elastically and vertically and are exposed to the chamber 49. Please also refer to FIG. 1. The chamber 49 of the eSATA plug 45 corresponds to the inserted tongue 16 of the eSATA connector socket 15 so that the electrical connection may be created. At this time, its terminal connection points 48 are in elastic contact with the contacts 26 of the second terminals 25.

In the conventional signal cable connector, the USB connector socket 11 only can be electrically connected to the inserted USB plug, while the eSATA connector socket 15 only can be electrically connected to the inserted eSATA plug. That is, the sockets cannot be shared. However, the functional requirements of the current computer are greatly increased day by day, and the computer may only need to be connected to four signal cables with the USB plugs but need not to be connected to one signal cable with the eSATA plug according to various requirements of the user. Also, the computer may not need to be connected one signal cable with the USB plug but need to be connected to four signal cables with the eSATA plugs. Thus, the computer must have four USB connector sockets and four eSATA connector sockets according to different requirements of the users. Thus, the space is wasted and the cost is increased.

For the sake of usage, a socket structure for the signal cable with the USB plug and the signal cable with the eSATA plug has been proposed. However, the connection points of the USB plug and the eSATA plug have partially overlapped X coordinates in the sequentially arranged direction of the terminals. So, the existing common sockets may be classified into two kinds.

In the first kind, four first terminals connected to the connection points of the USB plug and seven second terminals connected to the connection points of the eSATA plug are respectively disposed on two sides of the tongue. However, the elastic moving space of the first terminal is extremely small because the tongue is very thin.

In the second kind, four first terminals connected to the connection points of the USB plug and seven second terminals connected to the connection points of the eSATA plug are disposed on the same surface of the tongue. The four first terminals must be disposed in the gaps between the seven second terminals. Thus, when the USB plug is plugged, the connection points of the USB plug cannot be precisely aligned with and connected to the first terminals. Thus, the tolerance for the electrical connection is very small.

Furthermore, in order to shorten the transmission time, the current USB plug has been developed to satisfy the specification of USB 3.0. The USB 2.0 plug and the USB 3.0 plug have the same shape. However, the connection interface of the USB 3.0 plug has one additional row of terminals as compared with the USB 2.0 plug so that its transmission speed is higher. Thus, if the USB 3.0 plug and the eSATA plug need to share a socket, then the shared socket needs to have three rows of terminals, and the difficulty in manufacturing is further increased.

### SUMMARY OF THE INVENTION

It is therefore an object of the invention to provide a socket structure, in which a tongue is replaced with a circuit board formed with circuit connection points so that the manufacturing processes become easy.

To achieve the above-identified object, the invention provides a socket structure including a plastic base, a connection slot, a circuit board and pin terminals. The connection slot may be engaged with an inserted plug. The circuit board positioned in the plastic base and located in the connection slot has many first traces. Each first trace has a first contact on one surface of a front section of the circuit board, and a second contact on a rear section of the circuit board. The first contacts are electrically connected to the plug. The pin terminals are electrically connected to the second contacts of the first traces. One end of each of the pin terminals extends out of the plastic base.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a front view showing a conventional signal cable connector.

FIG. 2 is a schematic front view showing a conventional USB plug.

FIG. 3 is a schematic front view showing a conventional eSATA plug.

FIG. 4 is a pictorially exploded view showing a first embodiment of the invention.

FIG. 5 is a pictorially assembled view showing the first embodiment of the invention.

FIG. 6 is a cross-sectional side view showing the first embodiment of the invention.

FIG. 7 is a pictorial view showing an assembled state of the first embodiment of the invention.

FIG. 8 is a cross-sectional side view showing a used state of an eSATA plug assembled in the first embodiment of the invention.

FIG. 9 is a cross-sectional side view showing a used state of a USB 3.0 plug assembled in the first embodiment of the invention.

FIG. 10 is a pictorially assembled view showing a second embodiment of the invention.

FIG. 11 is a cross-sectional side view showing a third embodiment of the invention.

FIG. 12 is a cross-sectional side view showing a fourth embodiment of the invention.

FIG. 13 is a pictorially exploded rear view showing a fifth embodiment of the invention.

FIG. 14 is a pictorially exploded front view showing the fifth embodiment of the invention.

FIG. 15 is a pictorially exploded rear view showing a sixth embodiment of the invention.

FIG. 16 is a pictorially exploded view showing a seventh embodiment of the invention.

FIG. 17 is a pictorially assembled view showing the seventh embodiment of the invention.

FIG. 18 is a cross-sectional side view showing the seventh embodiment of the invention.

FIG. 19 is a pictorial view showing a circuit board combined with pin terminals according to the seventh embodiment of the invention.

FIG. 20 is a cross-sectional view showing the circuit board combined with the pin terminals according to the seventh embodiment of the invention.

FIG. 21 is a cross-sectional view showing the circuit board combined with the pin terminals according to the seventh embodiment of the invention.

FIG. 22 is a pictorially exploded view showing an eighth embodiment of the invention.

FIG. 23 is a pictorially assembled view showing the eighth embodiment of the invention.

FIG. 24 is a pictorially exploded view showing a ninth embodiment of the invention.

FIG. 25 is a pictorially assembled view showing the ninth embodiment of the invention.

FIG. 26 is a pictorially assembled view showing a tenth embodiment of the invention.

FIG. 27 is an assembled front view showing the tenth embodiment of the invention.

FIG. 28 is a pictorially assembled view showing an eleventh embodiment of the invention.

FIG. 29 is a pictorially assembled view showing the eleventh embodiment of the invention.

FIG. 30 is a pictorially assembled view showing a twelfth embodiment of the invention.

FIG. 31 is a pictorially exploded view showing a thirteenth embodiment of the invention.

FIG. 32 is a pictorially assembled view showing the thirteenth embodiment of the invention.

FIG. 33 is a pictorial bottom view showing a circuit board according to the thirteenth embodiment of the invention.

FIG. 34 is a pictorially assembled view showing a fourteenth embodiment of the invention.

FIG. 35 is a pictorial view showing connection terminals bonded to a circuit board according to a fifteenth embodiment of the invention.

FIG. 36 is a cross-sectional side view showing a sixteenth embodiment of the invention.

FIG. 37 is a cross-sectional side view showing a seventeenth embodiment of the invention.

FIG. 38 is a top view showing a circuit board according to the seventeenth embodiment of the invention.

FIG. 39 is a cross-sectional side view showing an eighteenth embodiment of the invention.

FIG. 40 is a top view showing a circuit board according to an eighteenth embodiment of the invention.

FIG. 41 is a cross-sectional side view showing a nineteenth embodiment of the invention.

FIG. 42 is a top view showing a circuit board according to the nineteenth embodiment of the invention.

FIG. 43 is a pictorially exploded view showing a twentieth embodiment of the invention.

FIG. 44 is a pictorially assembled view showing the twentieth embodiment of the invention.

FIG. 45 is a front view showing the twentieth embodiment of the invention.

FIG. 46 is a pictorially exploded view showing a 21^{st} embodiment of the invention.

FIG. 47 is a pictorial view showing a bottom surface of a circuit board according to the 21^{st} embodiment of the invention.

FIG. 48 is a front view showing the 21^{st} embodiment of the invention.

FIG. 49 is a pictorially assembled view showing the 21^{st} embodiment of the invention.

FIG. 50 is a pictorially exploded view showing a 22^{nd} embodiment of the invention.

FIG. 51 is a pictorial view showing a bottom surface of a circuit board according to a 22^{nd} embodiment of the invention.

FIG. 52 is a front view showing the 22^{nd} embodiment of the invention.

FIG. 53 is a pictorially exploded view showing a 23^{rd} embodiment of the invention.

FIG. 54 is a pictorial view showing a bottom surface of a circuit board showing the 23^{rd} embodiment of the invention.

FIG. 55 is a front view showing the 23^{rd} embodiment of the invention.

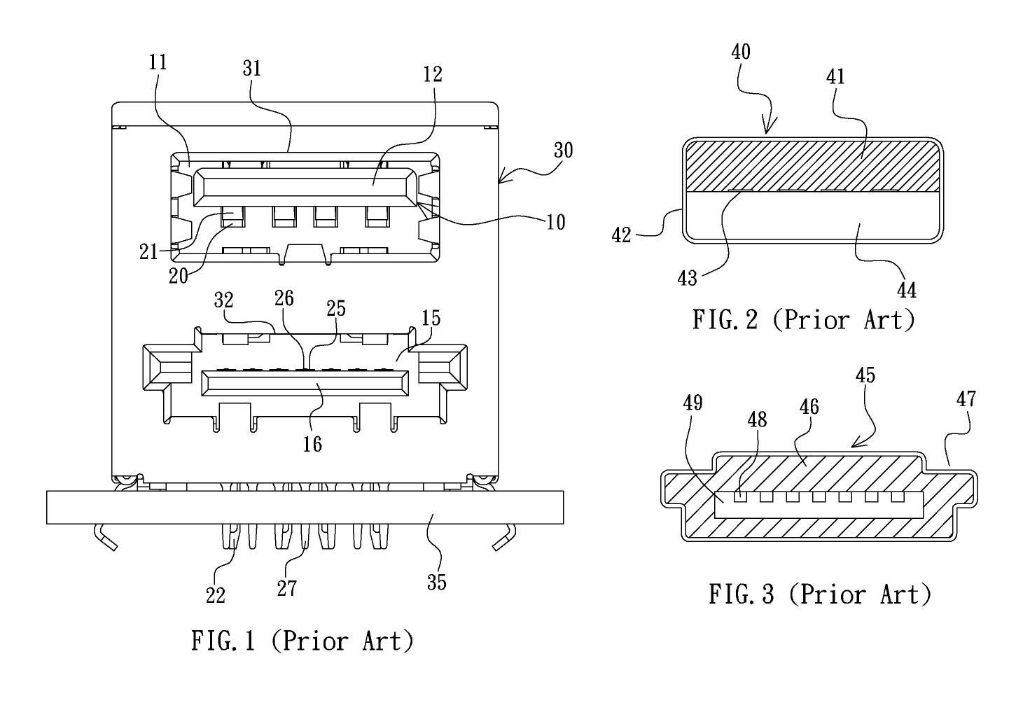

### DETAILED DESCRIPTION OF THE INVENTION

The present invention will be apparent from the following detailed description, which proceeds with reference to the accompanying drawings, wherein the same references relate to the same elements.

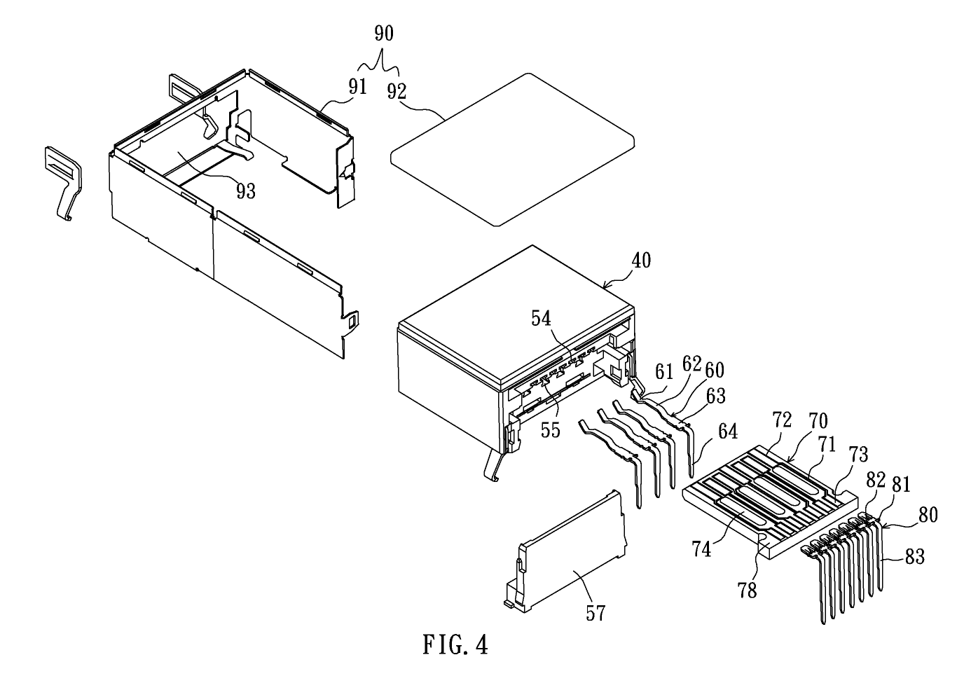

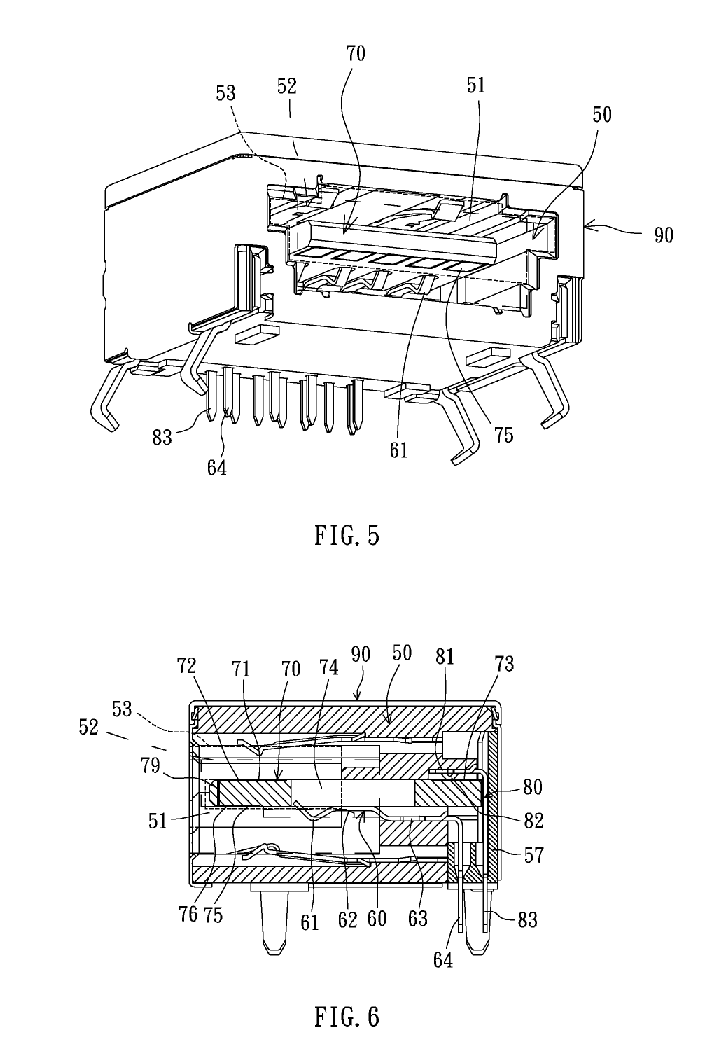

Referring to FIGS. 4 to 7, a socket structure of the invention includes a plastic base 50, one row of connection terminals 60, a circuit board 70, one row of pin terminals 80 and a metal casing 90.

The front end of the plastic base 50 is formed with a connection slot 51, which includes a first slot 52 and a second slot 53. The height of the second slot 53 is smaller than that of the first slot 52, and the width of the second slot 53 is greater than that of the first slot 52. The first and second slots 52 and 53 share a common chamber. The first slot 52 may be engaged with an inserted USB plug. The second slot 53 may be engaged with an inserted eSATA plug. The rear end of the plastic base 50 is formed with one row of slots 54, under which one row of slots 55 are disposed. A rear cover 57 covers the rear end thereof from bottom to top.

The one row of connection terminals 60 are separately arranged and fixed to the plastic base 50, and the connection terminal 60 has a contact 61, an extension 62, a fixing portion 63 and a pin 64 from front to rear. The fixing portion 63 is fixed to the slot 55 of the plastic base 50.

The circuit board 70 is disposed in the connection slot 51. Seven first traces 71 are disposed on the circuit board 70. The first traces 71 have first connection points 72 on a front section of the surface of the circuit board 70, and second connection points 73 on the rear section of the same surface of the circuit board 70. Four through slots 74 are separately arranged on the circuit board 70 and extend from front to rear. Five second traces 75 are disposed on the bottom surface of the circuit board 70. The second traces 75 have first connection points 76 on the front section of the bottom surface of the circuit board. The first connection point 76 of the second trace 75 is electrically connected to the first connection point 72 of the first trace 71 through a wire 79. Two sides of the rear end of the circuit board 70 are formed with projections 78 to be engaged with the plastic base 50. The circuit board 70 is inserted into and positioned between the slots 54 and 55 from the rear side of the plastic base 50. The contact 61 of the connection terminal 60 projects beyond the bottom surface of the circuit board 70 and may be elastically moved in the through slot 74.

There are seven pin terminals 80. One end of each pin terminal 80 has a horizontal fixing portion 81. The fixing portion 81 is prodded downwardly to form a projecting point 82. The fixing portion 81 is engaged with the slot 54 in the back of the plastic base 50. The projecting point 82 tightly presses the second connection point 73 of the trace to create the electrical connection, and the other end of the each pin terminal 80 is formed with a longitudinal pin 83 extending out of the plastic base.

In this embodiment, five second traces 75 are respectively electrically connected to five first traces 71. That is, the pin terminals 80 are shared.

The metal casing 90 covers the plastic base 50 and has a main body 91 and an upper cover 92. The main body 91 includes peripheral surfaces connected together, and has a front surface formed with an opening 93 from which the connection slot 51 of the plastic base 50 is exposed.

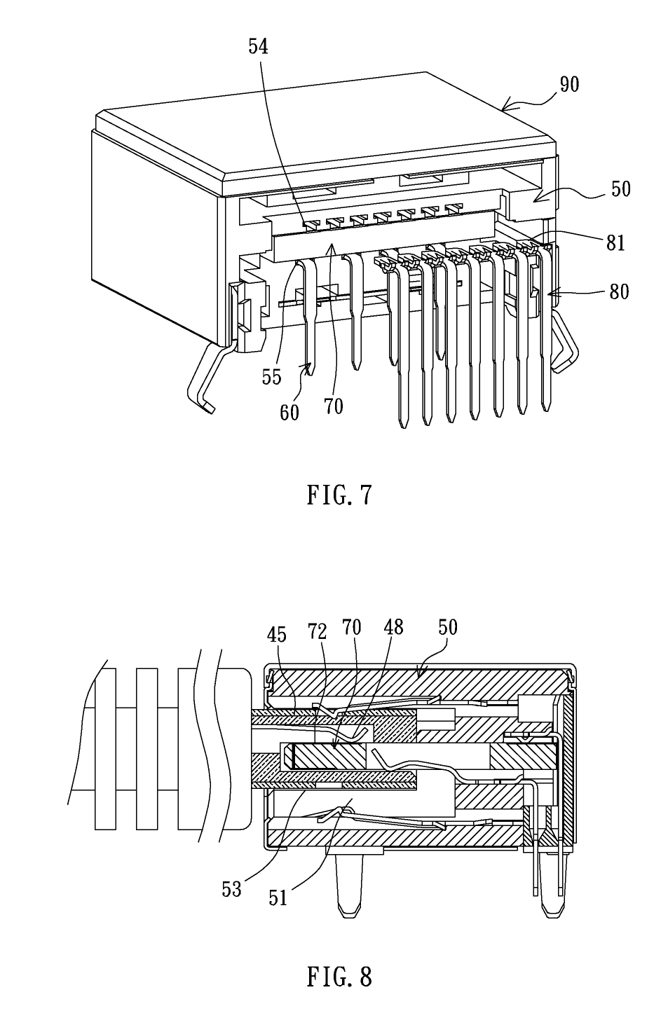

In assembly, as shown in FIG. 7, the one row of connection terminals 60 are assembled into the plastic base 50 from the rear side, and their fixing portions 63 are engaged with the slots 55. Then, the circuit board 70 is assembled with the plastic base 50 from the rear side, and is engaged with and disposed between the slots 54 and 55. Finally, the fixing portions 81 of the one row of pin terminals 80 are installed into the slots 54 of the plastic base 50 from the rear side, and the rear cover 57 is closed to form a stop on the rear side of the circuit board 70.

As shown in FIG. 8, when the eSATA plug 45 is inserted into the connection slot 51, it can be engaged with and positioned in the second slot 53, wherein the seven terminal connection points 48 themselves are elastic connection points and are thus electrically connected to the first connection points 72 of the first traces on the circuit board 70.

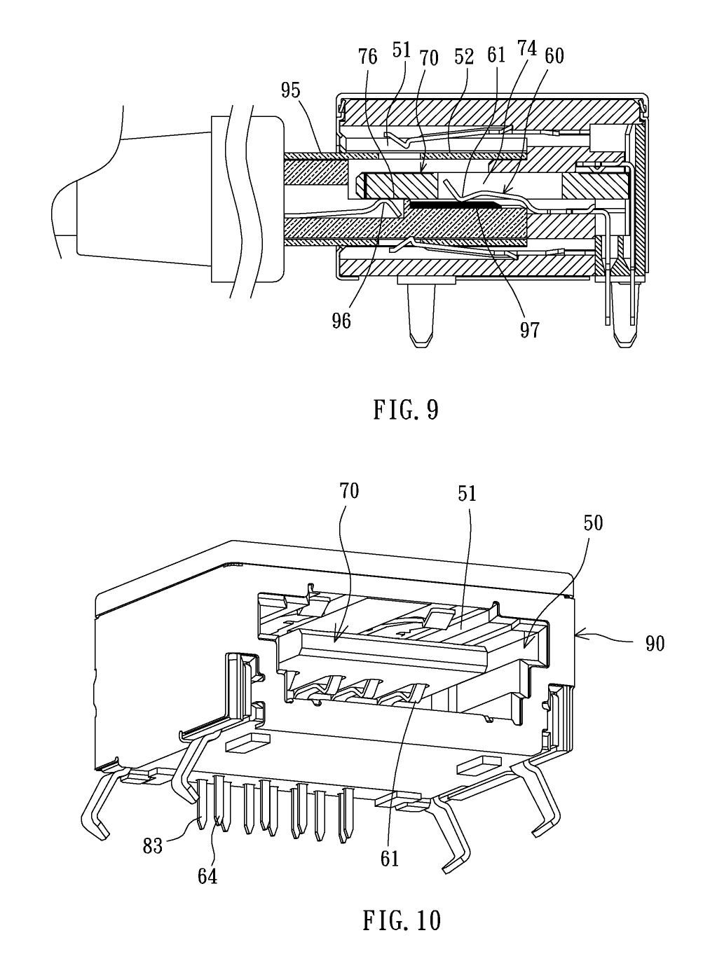

As shown in FIG. 9, when the USB 3.0 plug 95 is inserted into the connection slot 51, it can be engaged with and positioned in the first slot 52, wherein the four terminal connection points 97, which cannot be moved elastically, are in elastic contact with the contacts 61 of the four connection terminals 60. The connection terminal 60 may be elastically moved into the through slot 74. Five terminal connection points 96 themselves are elastic connection points, and are thus electrically connected to the first connection points 76 of the second traces on the bottom surface of the circuit board 70.

According to the above-mentioned description, it is obtained that the connection slot 51 of the invention can receive two different signal cable plugs, such as USB 3.0 plug 90 and the eSATA plug 45, and can thus be shared. Thus, the computer only needs to be provided with several connection slots to provide various options for the users, and the computer needs not to be provided with the USB connector sockets and the eSATA connector sockets so that the space may be saved.

Moreover, the unique design of the invention further has the following advantages.

First, the connection points that need not to be elastically moved are respectively disposed on two surfaces of the circuit board 70 to replace two rows of connection terminals. So, only one row of elastically movable connection terminals need to be provided in this embodiment so that the manufacturing processes are simplified.

Second, the traces and the connection points disposed on two surfaces of the circuit board 70 can easily get rid of the one row of elastically movable connection terminals 60 so that the manufacturing processes become easier.

Third, the circuit board 70 can replace the tongue so that the injection molding of the plastic base 50 becomes more simplified.

As shown in FIG. 10, the second embodiment of the invention is almost the same as the first embodiment except that the bottom surface of the circuit board 70 of the second embodiment does not have five second traces. The USB plug to be connected to this embodiment is the USB 2.0 plug because the USB 2.0 plug only needs to be electrically connected to the contact 61 of the connection terminal.

As shown in FIG. 11, the third embodiment of the invention is almost the same as the first embodiment except that the second trace 75 on the bottom surface of the circuit board 70 of the third embodiment extending to the rear section of the bottom surface of the circuit board 70 has a second connection point 77. The second connection point 77 is aligned with the second connection point 73 of the first trace 71 and is electrically thereto through the wire 79. Thus, the electrical connection between the second connection point 77 and the second connection point 73 can be easily designed and provided.

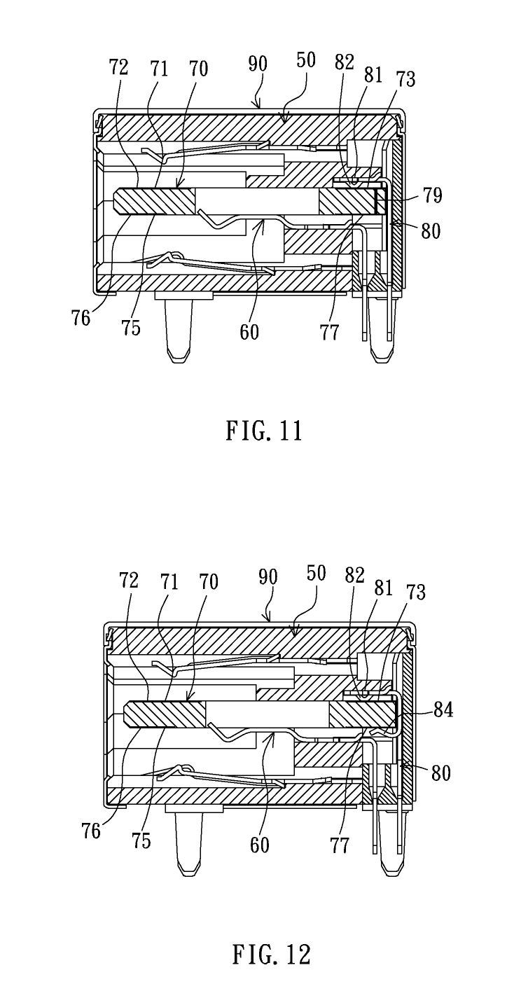

As shown in FIG. 12, the fourth embodiment of the invention is almost the same as the third embodiment except that the fixing portion of the pin terminal 80 of the fourth embodiment is formed with a transversal elastic sheet 84 on the bottom side. The elastic sheet 84 is in elastic contact with the second connection point 77 of the second trace 75.

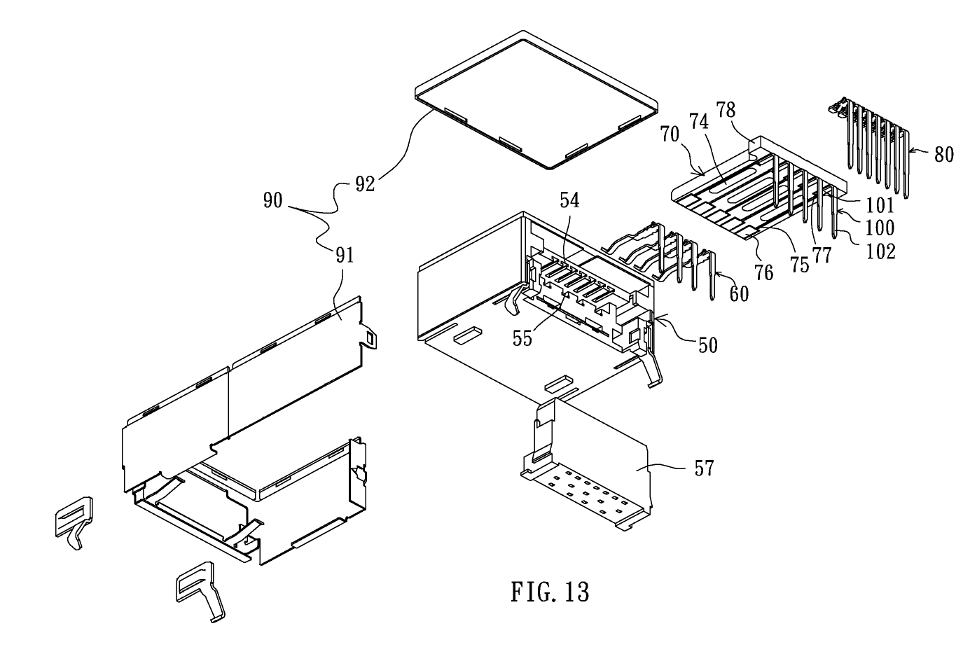

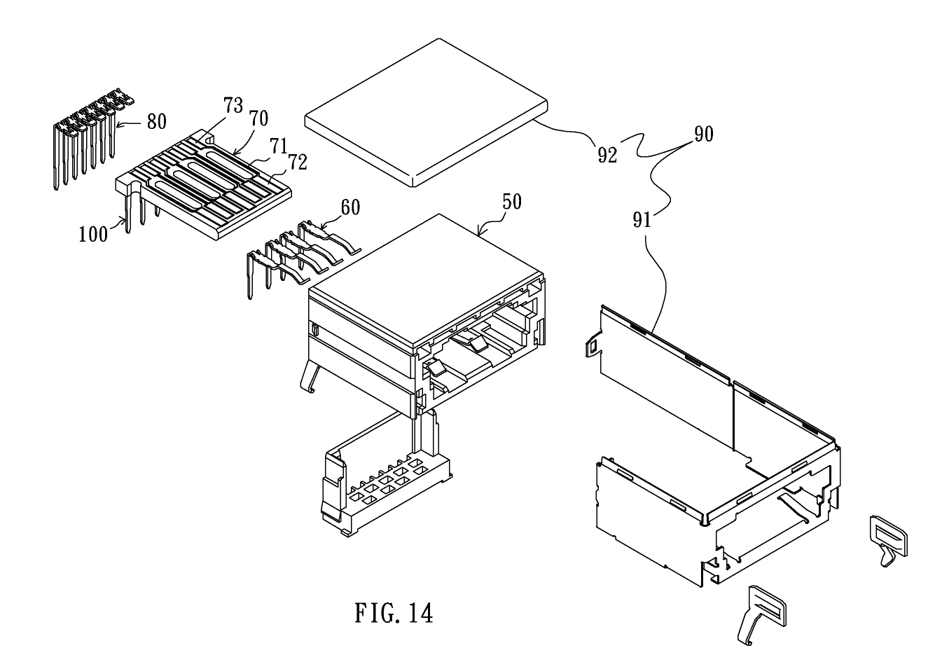

As shown in FIGS. 13 and 14, the fifth embodiment of the invention is almost the same as the third embodiment except that the second trace 75 on the bottom surface of the circuit board 70 of the fifth embodiment is electrically connected to an independent pin terminal 100. That is, the second trace 75 does not share the pin terminal 80 with the first trace 71. One end of the pin terminal 100 is formed with a horizontal fixing portion 101 bonded to the second connection point 77 of the second trace 75, and the other end of the pin terminal 100 is formed with a longitudinal pin 102 extending out of the plastic base 50.

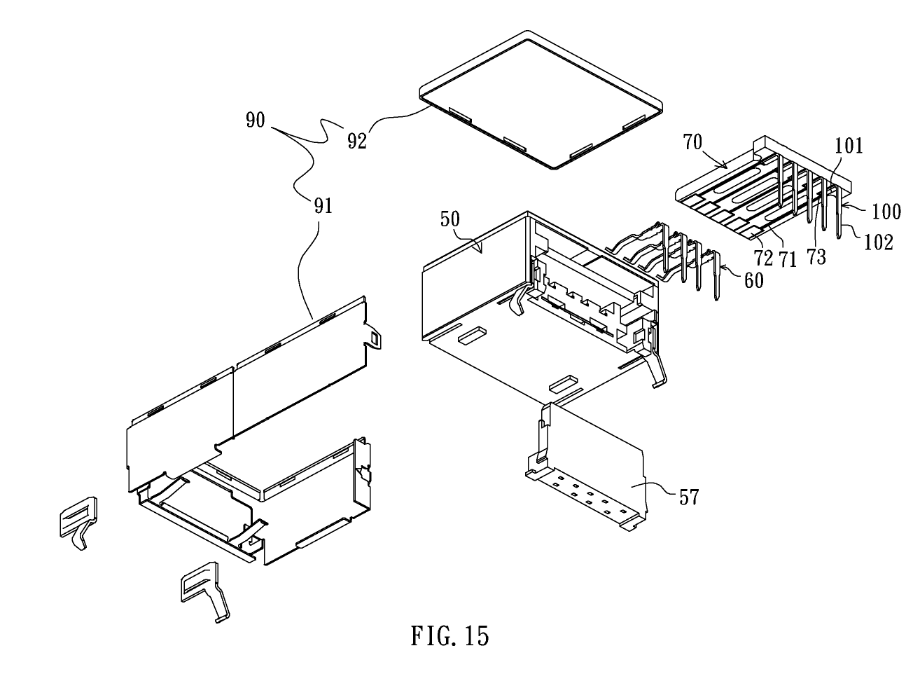

As shown in FIG. 15, the sixth embodiment of the invention is almost the same as the fifth embodiment except that no trace is disposed on the top surface of the circuit board 70 of the sixth embodiment, while only five first traces 71 are disposed on the bottom surface of the circuit board 70. The front section of the first trace 71 on the bottom side of the circuit board has a first connection point 72 and the rear section of the first trace 71 has a second connection point 73. The fixing portion 101 of the pin terminal 100 is bonded to the second connection point 73 of the first trace 71. This embodiment is a simplex USB connector socket for receiving the inserted USB 2.0 and USB 3.0 plugs.

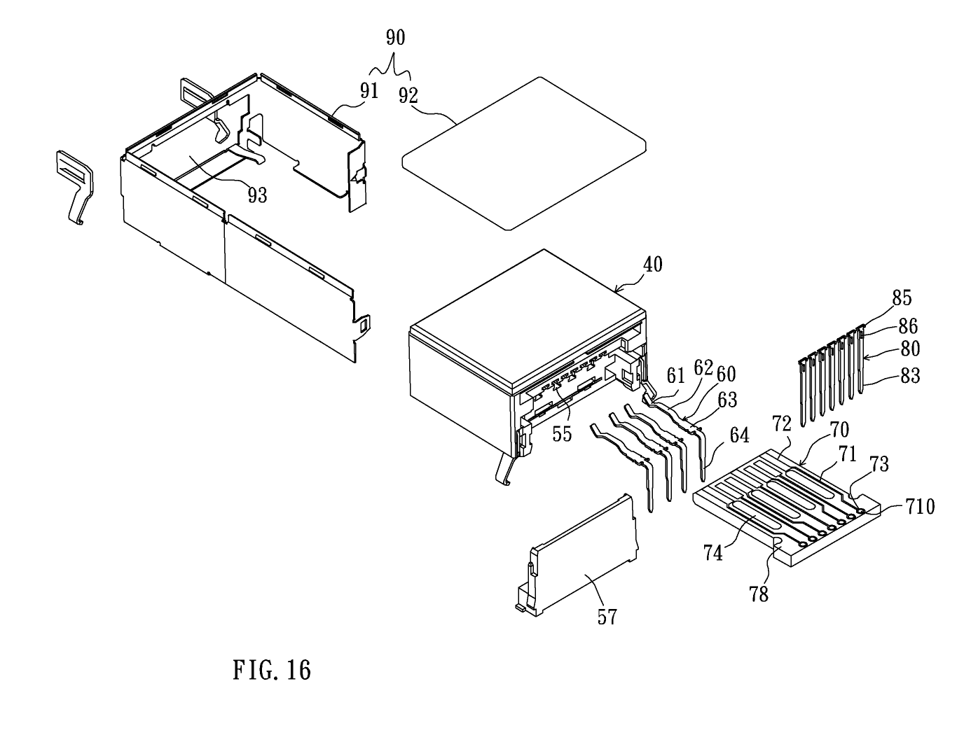

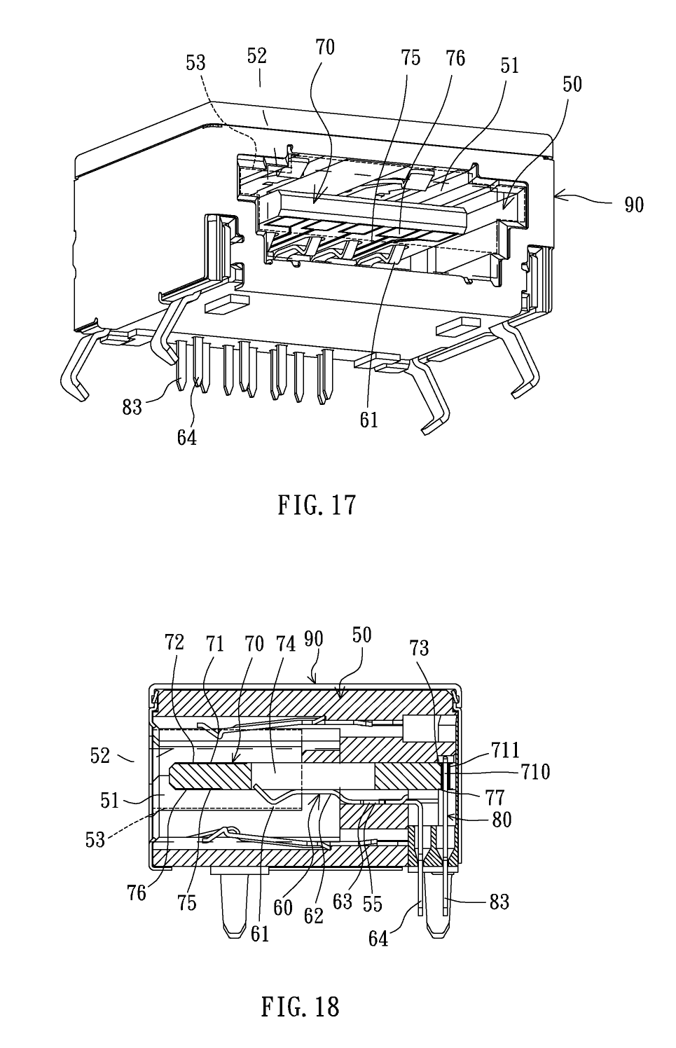

As shown in FIGS. 16 to 18, the seventh embodiment of the invention includes a plastic base 50, one row of connection terminals 60, a circuit board 70, one row of pin terminals 80 and a metal casing 90.

The front end of the plastic base 50 is formed with a connection slot 51, which includes a first slot 52 and a second slot 53. The height of the second slot 53 is smaller than that of the first slot 52, and the width of the second slot 53 is greater than that of the first slot 52. The first and second slots 52 and 53 share a common chamber. The first slot 52 may be engaged with an inserted USB plug. The second slot 53 may be engaged with an inserted eSATA plug. In addition, the rear end of the plastic base 50 is formed with one row of slots 55, and a rear cover 57 covers the rear end thereof from bottom to top.

The one row of connection terminals 60 are separately arranged and fixed to the plastic base 50. The terminal 60 has, from front to rear, a contact 61, an extension 62, a fixing portion 63 and a pin 64. The fixing portion 63 is fixed to the slot 55 of the plastic base 50.

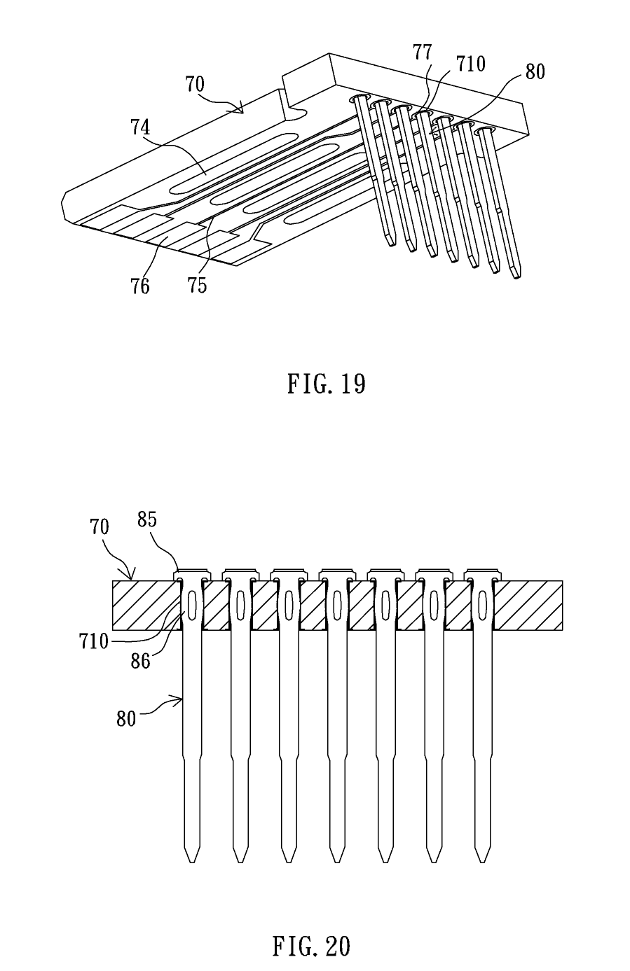

As shown in FIGS. 19 and 20, the circuit board 70 is disposed in the connection slot 51 and has a top surface formed with seven first traces 71. The first trace 71 has a first connection point 72 on the front section of the top surface of the circuit board, and has a second connection point 73 on the rear section of the top surface of the circuit board. The circuit board 70 is formed with four separately arranged through slots 74 from front to rear, the rear end of the circuit board 70 is formed with seven penetrating vias 710, and the bottom surface of the circuit board 70 is formed with five second traces 75. The second trace 75 has a first connection point 76 on the front section of the bottom surface of the circuit board and a second connection point 77 on the rear section of the bottom surface of the circuit board. The second connection points 77 of the five second traces 75 are vertically aligned with the second connection points 73 of five of the first traces 71. The rear end of the circuit board 70 has seven penetrating vias 710. The inner wall of the via 710 is formed with a metal layer 711. The second connection points 73 of the seven first traces 71 are respectively electrically connected to the seven vias 710. The second connection points 77 of the five second traces 75 are respectively electrically connected to five of the vias 710. Two sides of the rear end of the circuit board 70 are formed with projections 78, which are to be engaged with the plastic base 50 installed from the rear side and located above the slots 55. The contact 61 of the connection terminal 60 projects beyond the bottom surface of the circuit board 70 and may be elastically moved in the through slot 74.

There are seven pin terminals 80 extending longitudinally. The top end of the pin terminal 80 has a stopping portion 85. An elastic pressing portion 86 is disposed below the stopping portion 85. The middle of the pressing portion 86 is formed with an opening to generate the elastic effect. The bottom end of the pin terminal 80 is formed with a longitudinal pin 83. The seven pin terminals 80 are respectively inserted into the seven vias 710 of the circuit board 70 from top to bottom. The stopping portion 85 stops on the top surface of the circuit board 70, and the pressing portion 86 tightly elastically presses against the via 710 so that the pin terminals 80 are electrically connected to the second connection points 73 of the first traces 71 and the second connection points 77 of the second traces 75.

The metal casing 90 covers the plastic base 50 and has a main body 91 and an upper cover 92. The main body 91 includes peripheral surfaces connected together, and a front surface formed with an opening 93 from which the connection slot 51 of the plastic base 50 is exposed.

The pin terminals 80 of this embodiment is directly inserted into and tightly presses against the vias 710, and the vias 710 are electrically connected to the second connection points 73 of the first traces 71 and the second connection points 77 of the second trace 75 so that the structure becomes simpler and can be easily manufactured.

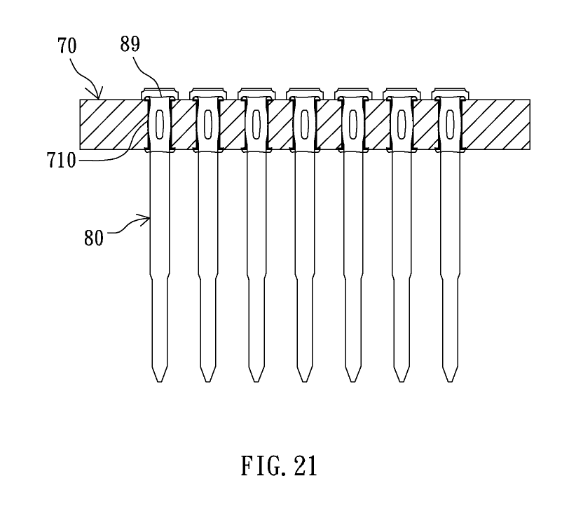

As shown in FIG. 21, in order to ensure the electrical connection between the pin terminal 80 and the via 710, a soldering paste 89 may be applied to the via 710 so that the pin terminal 80 can be inserted into the via 710 tightly and bonded thereto.

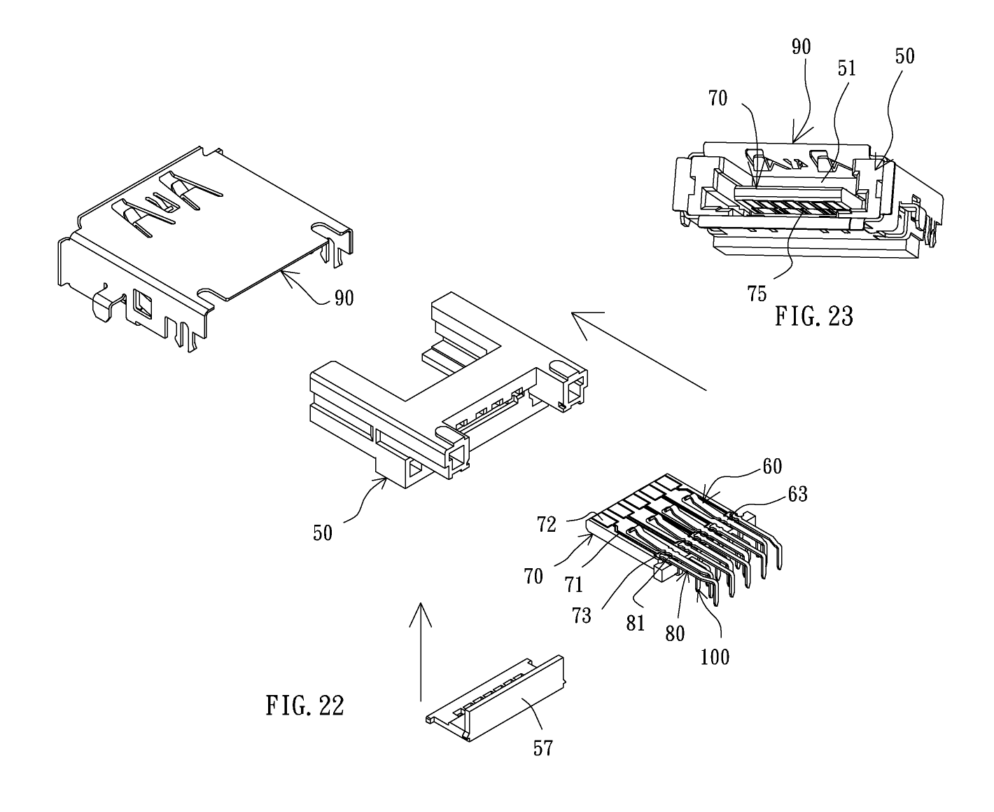

As shown in FIGS. 22 and 23, the eighth embodiment of the invention is almost the same as the fifth embodiment except that this embodiment has a plate-sinking configuration. That is, the structure is partially sunk into the mainboard when being connected thereto. So, the pin lengths of the connection terminal 60, the pin terminal 80 and the pin terminal 100 are shorter than those of the previous embodiments. In addition, the fixing portion 63 of the connection terminal 60 is directly bonded to the circuit board 70, the fixing portion 81 of the connection terminal 80 is also bonded to the second connection point 73 of the first trace 71, and the fixing portion of the connection terminal 100 is also bonded to the second connection point of the second trace 75 on the bottom surface of the circuit board 70 in a manner similar to the fifth embodiment. The plastic base 50 forms two sides of the connection slot 51, and the metal casing 90 forms the top and bottom surfaces of the connection slot 51.

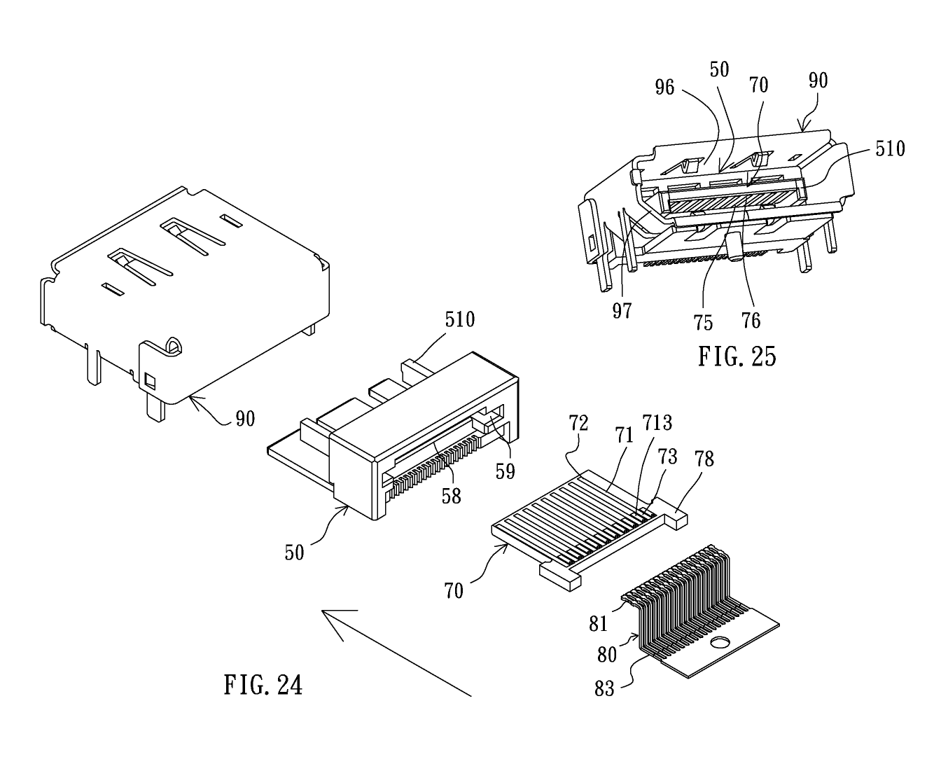

As shown in FIGS. 24 and 25, the ninth embodiment of the invention is almost the same as the fifth embodiment. In this embodiment, a display port socket is provided. The display port socket includes a plastic base 50, a circuit board 70, one row of pin terminals 80 and a metal casing 90.

The plastic base 50 has a horizontal through hole 58. Two sides of the through hole 58 are formed with slots 59. Two longitudinal plates 510 extending forwards are disposed near two sides of the front end of the plastic base 50.

The metal casing 90 covers the plastic base 50 and is formed with a connection slot 96. A bottom end of one side of the connection slot 96 is narrower than a top end of the one side of the connection slot 96 so that an inclined surface 97 is formed.

The circuit board 70 is disposed in the connection slot 96 and has a top surface formed with ten separately arranged first traces 71. The first trace 71 has a first connection point 72 on the front section of the top surface of the circuit board, and a second connection point 73 on the rear section of the top surface of the circuit board. A connection point 713 is formed between the second connection points 73. The bottom surface of the circuit board 70 is formed with ten separately arranged second traces 75. The second traces 75 and the first traces 71 are staggered vertically. The second trace 75 has a first connection point 76 on the front section of the bottom surface of the circuit board. The rear section of the second trace 75 corresponds to one connection point 713 and the second trace 75 is electrically connected to the connection point 713 through a wire. Two sides of the rear end of the circuit board 70 are formed with projections 78. The circuit board 70 passes through the through hole of the plastic base 50 from rear to front. The projections 78 on two sides of the circuit board 70 are engaged with the slots 59. At this time, the two longitudinal plates 510 of the plastic base 50 are disposed on two sides of the circuit board 70 to form the projections extending downwardly.

There are twenty pin terminals 80. One end of the pin terminal 80 is formed with a horizontal fixing portion 81. The fixing portion 81 of each pin terminal 80 is bonded to a second connection point 73 of a first trace or a connection point 713. The other end of the pin terminal 80 is formed with a horizontal pin 83 extending out of the plastic base 50.

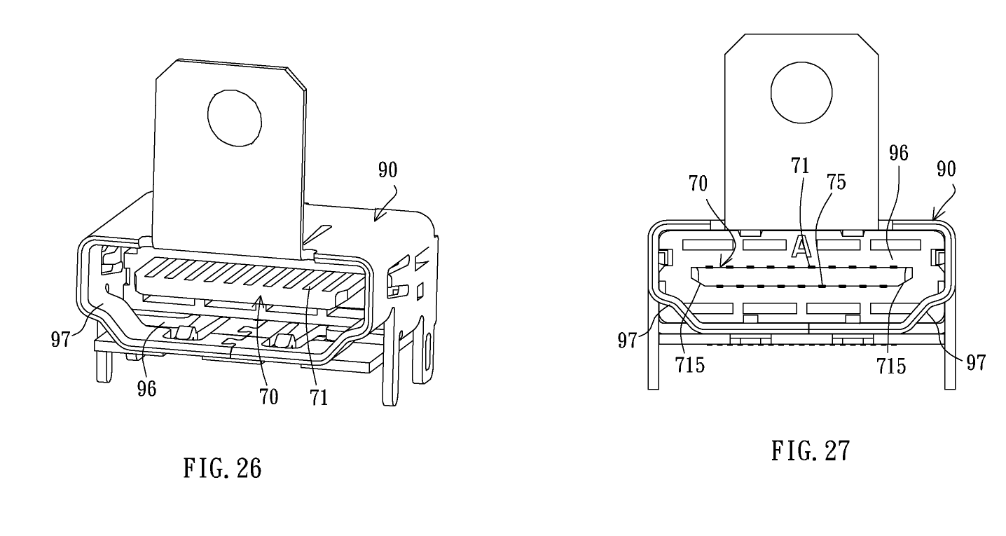

As shown in FIGS. 26 and 27, the tenth embodiment of the invention is almost the same as the ninth embodiment except that the tenth embodiment provides a high definition multimedia interface (HDMI) socket. The top surface of the circuit board 70 is formed with ten first traces 71 and the bottom surface of the circuit board 70 is formed with only nine second traces 75. The bottom ends of two sides of the circuit board 70 are narrower than the top ends thereof so that two inclined surfaces 715 are formed. The bottom ends of two sides of the connection slot 96 are narrower than the top ends thereof so that two inclined surfaces 97 are formed.

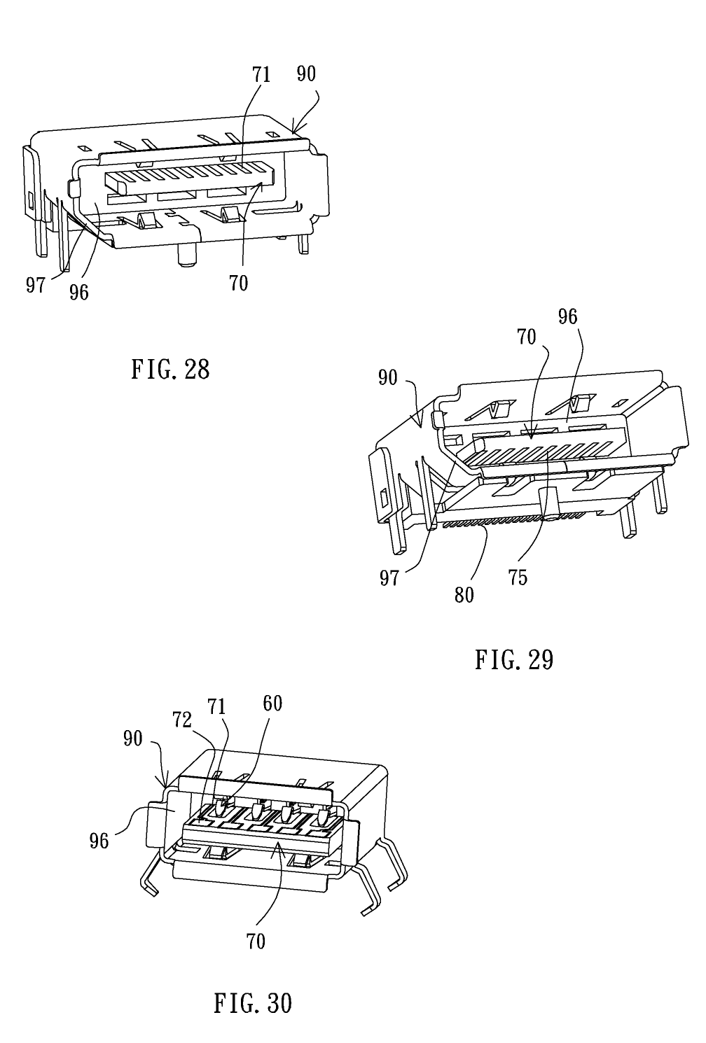

As shown in FIGS. 28 and 29, the eleventh embodiment of the invention is almost the same as the ninth embodiment except that the eleventh embodiment provides a common socket for a display port and a HDMI. Two sides of the circuit board 70 are not formed with the downward projections, the top surface of the circuit board 70 is formed with ten first traces 71, and the bottom surface of the circuit board 70 is formed with ten second traces 75. The bottom end of only one side of the connection slot 96 is narrower than the top end thereof so that an inclined surface 97 is formed.

As shown in FIG. 30, the twelfth embodiment of the invention is almost the same as the sixth embodiment and provides a simplex USB connector socket, into which a USB 2.0 plug and a USB 3.0 plug may be inserted. The difference between the twelfth and the sixth embodiment is that the connection slot 96 of this embodiment is formed by the metal casing 90.

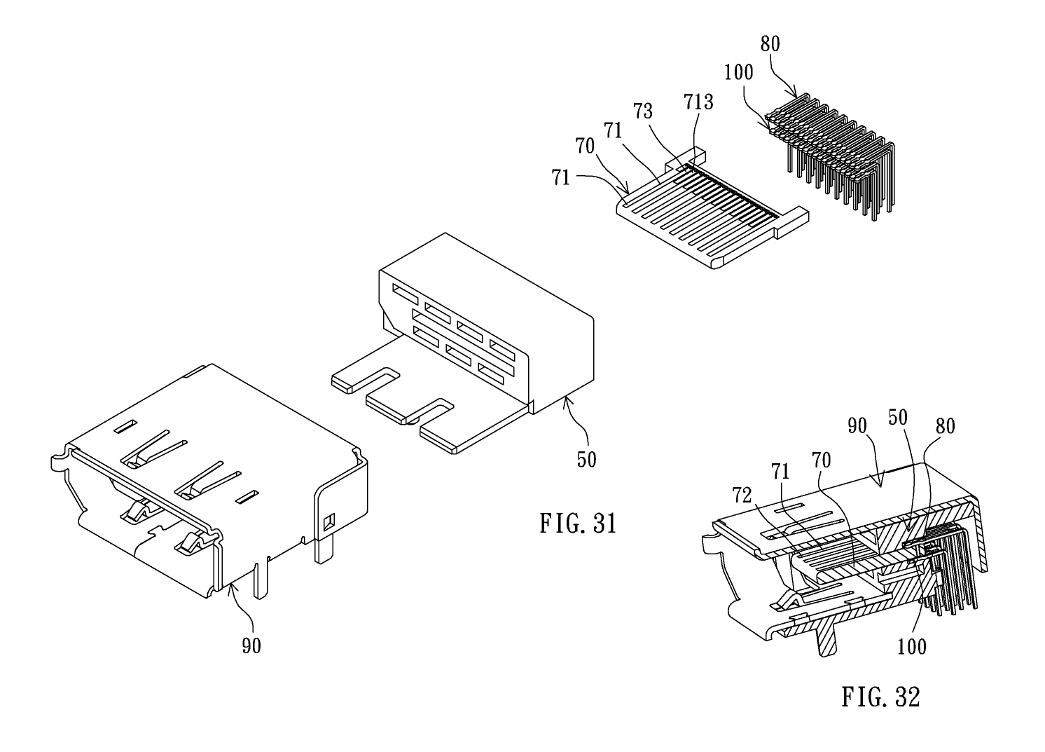

As shown in FIGS. 31 to 33, the common socket for the display port and the HDMI according to the thirteenth embodiment of the invention is almost the same as the eleventh embodiment except that two pin terminals are provided in the thirteenth embodiment. That is, there are 20 pin terminals 80 and 19 pin terminals 100. Each pin terminal has longitudinal pin. The 20 pin terminals 80 are respectively bonded to the second connection points 73 of the first traces 71 and the connection points 713 on the top surface of the circuit board 70, a connection point 714 is disposed between the second connection points 77 of the rear sections of second traces 75 on the bottom surface of the circuit board 70. The second connection point 73 of the one first trace 71 corresponds to one connection point 714 and is electrically connected thereto through a wire. The 19 pin terminals 100 are respectively bonded to the second connection points 77 of nine second traces 75 and ten connection points 714 on the bottom surface of the circuit board 70.

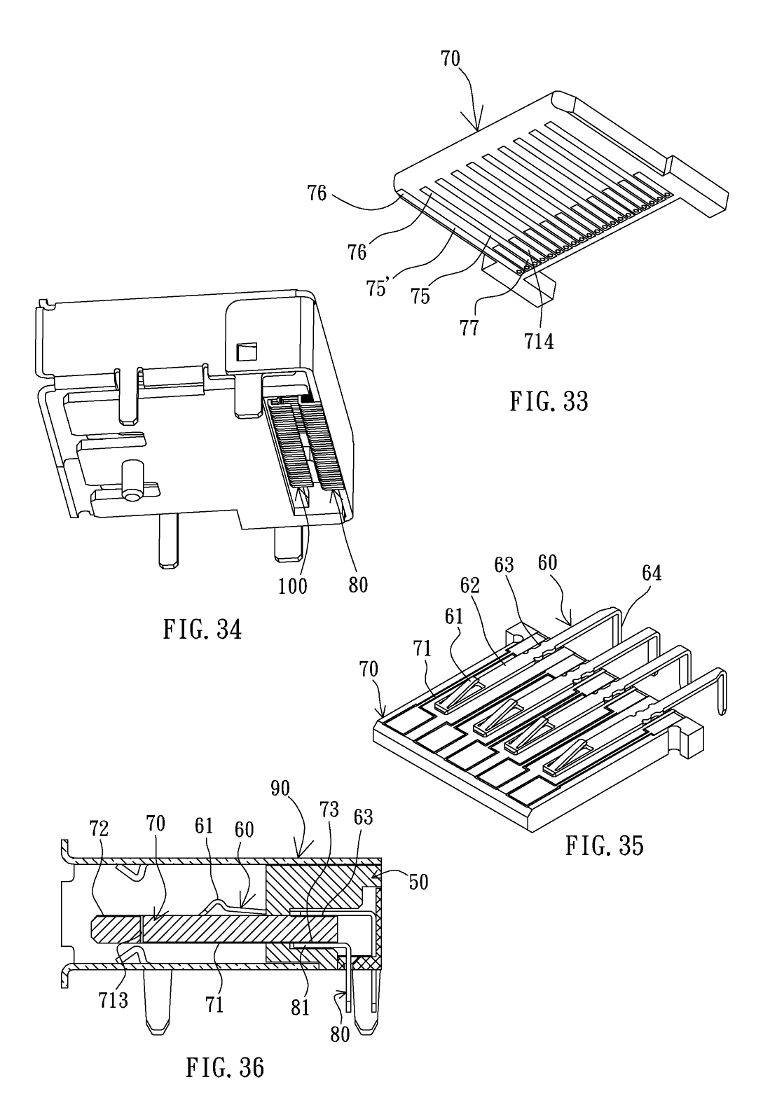

As shown in FIG. 33, there are ten second traces 75 on the bottom surface of the circuit board, and a second trace 75′ on one side is not shared. That is, the HDMI only has 19 connection points, which do not need to use the second trace 75′. The first connection point 76 of the second trace 75′ projects beyond the front end of the circuit board 70 by a higher extent than the first connection points 76 of the second traces 75. The pin terminal 100 is not bonded to the second connection point 77 of the second trace 75′.

According to the above-mentioned structure, when the display port plug is inserted for connection, the second trace 75′ is firstly ON so that the set of 20 pin terminals 80 are selected as the signal outputs. When the HDMI plug is inserted for connection, the second trace 75′ is OFF so that the other set of 19 pin terminals 100 are selected as the signal outputs.

As shown in FIG. 34, the fourteenth embodiment of the invention is almost the same as the thirteenth embodiment except that the pin terminals 80 and 100 have horizontal pins.

As shown in FIG. 35, the fifteenth embodiment of the invention is almost the same as the eighth embodiment except that the separately arranged through slots need not to be formed on the circuit board 70 so that the first traces 71 and the second traces can be easily disposed. The one row of connection terminals 60 are separately arranged and fixed to the circuit board 70. The connection terminal 60 has a contact 61, a extension 62, a fixing portion 63 and a pin 64. The contact 61 projects from the plate surface of the extension 62. One end of the contact 61 is connected to the extension 62 and gradually projects and extends, from front to rear, to the other end, which is an open end, and the contact 61 may be elastically moved up and down.

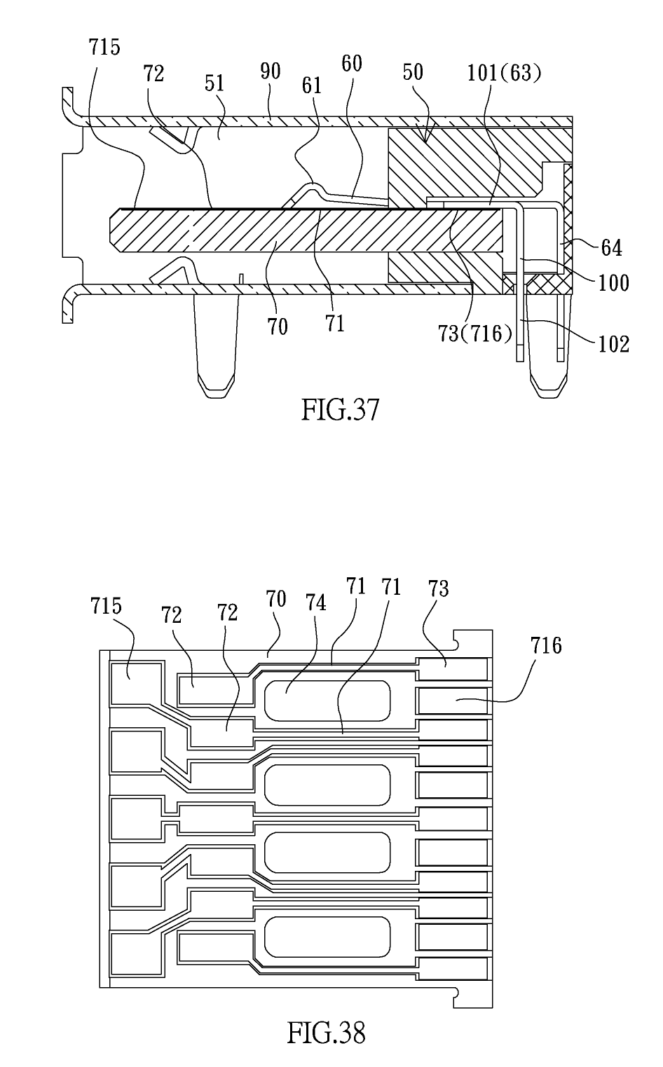

As shown in FIG. 36, the sixteenth embodiment of the invention is almost the same as the first embodiment except that this embodiment provides the socket for the USB 3.0 plug. The fixing portions 63 of the four connection terminals 60 are bonded to the top surface of the circuit board 70, and the contact 61 of the connection terminal 60 projects beyond the top surface of the circuit board 70. The bottom surface of the circuit board 70 is formed with five first traces 71, each of which has a second connection point 73 extending to the rear end of the bottom surface of the circuit board and, and has a first connection point 72 extending to the front end of the top surface of the circuit board through the via 713. The second connection points 73 are respectively bonded to the pin terminals 80 such that the first connection points 72 of the first traces 71 and the contacts 61 of the connection terminals 60 are disposed on the same surface of the circuit board 70. However, the fixing portions 63 of the connection terminals and the fixing portions 81 of the pin terminals 80 are fixed to opposite surfaces of the circuit board 70.
As shown in FIGS. 37 and 38, the seventeenth embodiment of the invention is almost the same as the first embodiment because it is also a common socket for the USB 3.0 plug and the eSATA plug. In this embodiment, the socket includes a plastic base 50, one row of connection terminals 60, a circuit board 70, one row of pin terminals 100 and a metal casing 90.

The circuit board 70 is mounted on the plastic base 50 and extends to the connection slot 51. The top surface of the circuit board 70 is formed with seven first traces 71, one row of seven first connection points 72 and one row of five third connection points 715. Each first trace 71 is electrically connected to the first connection point 72 and has a second connection point 73 at the rear end of the same surface of the circuit board. Each third connection point is electrically connected to one first trace 71. Each pin terminal 100 has a fixing portion 101 electrically connected to the first trace 71, and a pin 102 extending out of the plastic base 5. In addition, one row of four longitudinal through slots 74 corresponding to the one row of connection terminals 60 are formed on the circuit board 70. A bonding pad 716 is disposed on the top surface of the rear end of each through slot 74. The fixing portion 101 of the pin terminal 100 is bonded to the second connection point 72, and the fixing portion 63 of the connection terminal 60 is bonded to the bonding pad 716.

The third connection point 715 is disposed in front of the first connection point 72. The first connection point 72 is disposed in front of the contact 61 of the connection terminal 60. Three rows of connection points are disposed on the same surface of the circuit board 70.

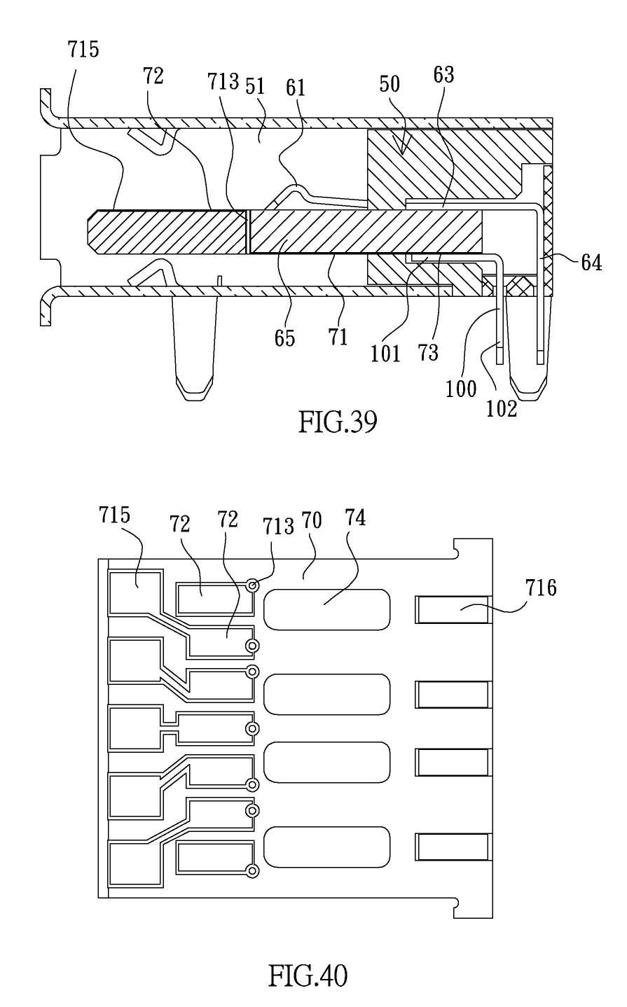

As shown in FIGS. 39 and 40, the eighteenth embodiment of the invention is almost the same as the seventeenth embodiment except that seven first traces 71 and seven second connection points 73 of this embodiment are disposed on the bottom surface of the circuit board 70. The first traces 71 are electrically connected to the second connection point 72 and the third connection point 715 on the top surface of the circuit board 70 through the vias 713. Thus, the fixing portions 101 of the pin terminals 100 and the fixing portions 63 of the connection terminals 60 are respectively disposed on opposite surfaces of the circuit board 70 so that the electrical interference can be reduced.

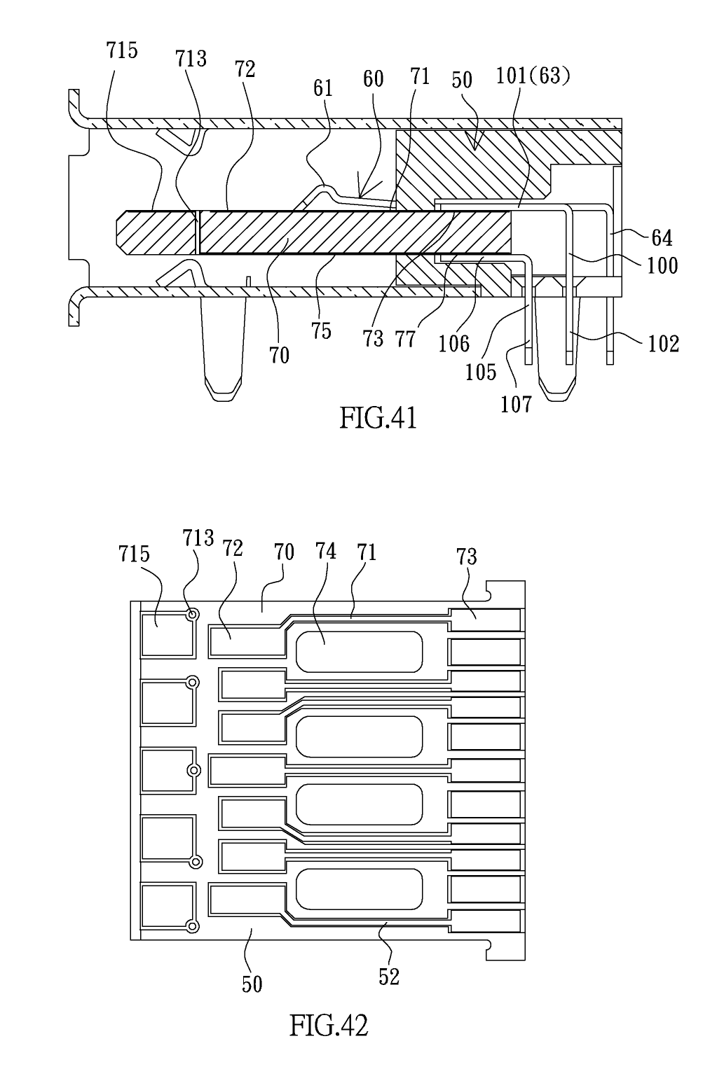

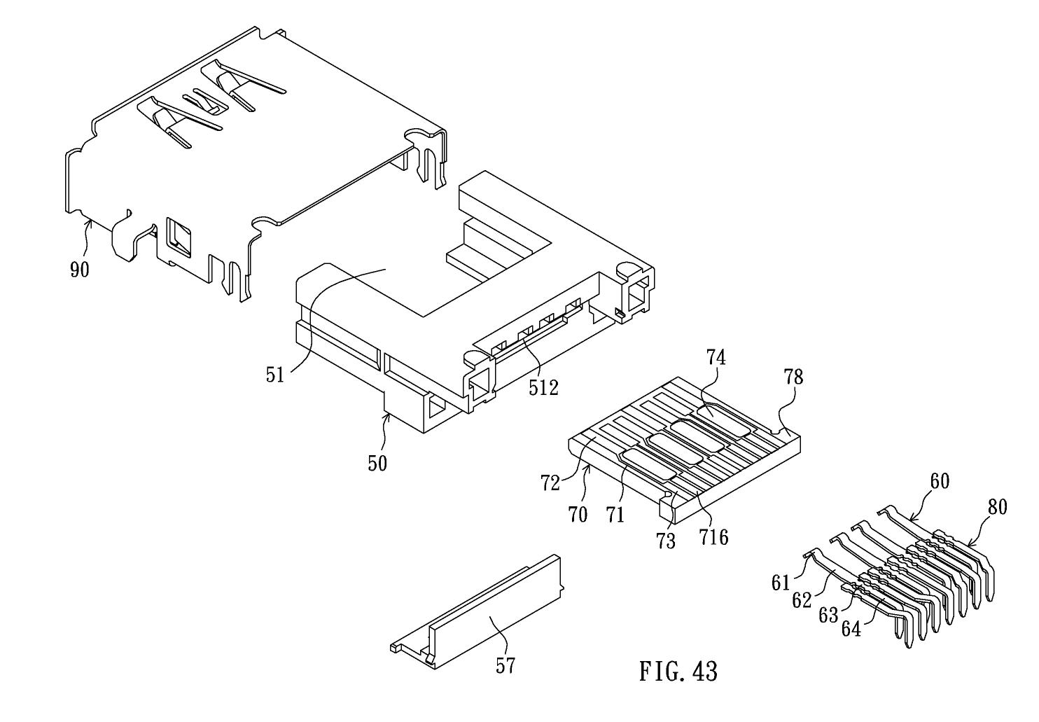

As shown in FIGS. 41 and 42, the nineteenth embodiment of the invention is almost the same as the seventeenth embodiment except that the bottom surface of the circuit board 70 of this embodiment is further formed with seven second traces 75, seven second connection points 77, and one row of pin terminals 105. Each second connection point 77 is disposed at a rear end of the circuit board 70 and electrically connected to a second trace 75. The pin terminal 105 has a fixing portion 106 bonded to the second connection point 77 and a pin 107 extending out of the plastic base 50. Each second trace 75 is further electrically connected to third connection point 715 on a top surface of the circuit board 70 through the via 713.

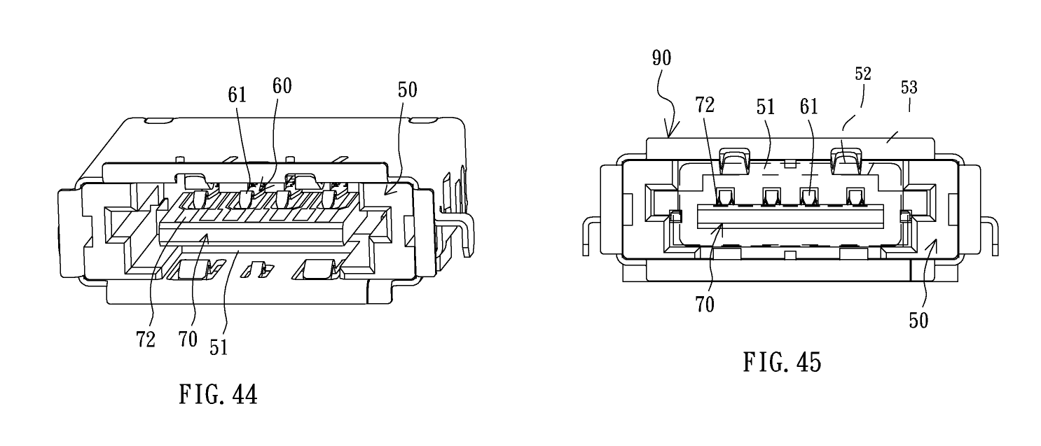

As shown in FIGS. 43 to 45, the twentieth embodiment of the invention is a common socket for the USB 2.0 plug and the eSATA plug and includes a plastic base 50, one row of connection terminals 60, a circuit board 70, one row of pin terminals 80 and a metal casing 90.

The front end of the plastic base 50 is formed with a connection slot 51, which includes a first slot 52 and a second slot 53. The second slot 53 has a height smaller than that of the first slot 52, and a width greater than that of the first slot 52. The first and second slots 52 and 53 share a common chamber. The first slot 52 may be engaged with an inserted USB plug. The second slot 53 may be engaged with an inserted eSATA plug. A rear cover 57 covers the rear end thereof from bottom to top. In addition, a fitting through hole 512 is formed from the rear end to the connection slot 51.

The circuit board 70 passes through the fitting through hole 512 of the plastic base 50 from the rear side and is in the form of a tongue disposed in the connection slot 51. The top surface of the circuit board 70 is formed with seven first traces 71. Each first trace 71 has a first connection point 72 on the top surface of the front section of the circuit board, and a second connection point 73 on the top surface of the rear section of the circuit board. One row of four bonding pads 716 are disposed between the seven second connection points 73. The circuit board 70 is formed with four through slots 74, which are separately arranged and extend from front to rear. Each through slot 74 corresponds to a bonding pad 716. The row of first connection points 72 is an e-SATA interface that may be electrically connected to the e-SATA plug. In addition, two sides of the rear end of the circuit board 70 are formed with projections 78 to be engaged with the plastic base 50.

The row of connection terminals 60 are separately arranged and fixed to the plastic base 50. Each connection terminal 60 has, from front to rear, an extension 62, a fixing portion 63 and a pin 64. The extension is curved to form a projecting contact 61 near its distal end. The fixing portion 63 is bonded and fixed to the second connection point 79 on the top surface of the circuit board. The second contact 61 projects beyond the top surface of the circuit board 70, and the extension 62 may be elastically moved in the through slot 74. The row of second contacts pertain to the USB interface and are four contacts that may be moved elastically and may be electrically connected to the USB plug.

There are seven pin terminals 80, each of which has one end formed with a horizontal fixing portion 81 bonded and fixed to the second connection point 73 on the top surface of the circuit board 70, and the other end formed with a longitudinal pin 83 extending out of the plastic base.

The metal casing 90 covers the plastic base 50 and has a front surface formed with an opening through which the connection slot 51 of the plastic base 50 is exposed.

The row of connection terminals 60 and the row of pin terminals 80 of this embodiment are bonded to the same surface of the circuit board. The fixing portions of the row of connection terminals and the fixing portions of the row of pin terminals are arranged in one row and are disposed at the same height. Thus, they can be manufactured by pressing one copper sheet so that the material cost is reduced. The row of connection terminals and the row of pin terminals after pressing are connected to a material tape so that the machining, such as electroplating and assembling, becomes simpler and the manufacturing cost may be reduced.

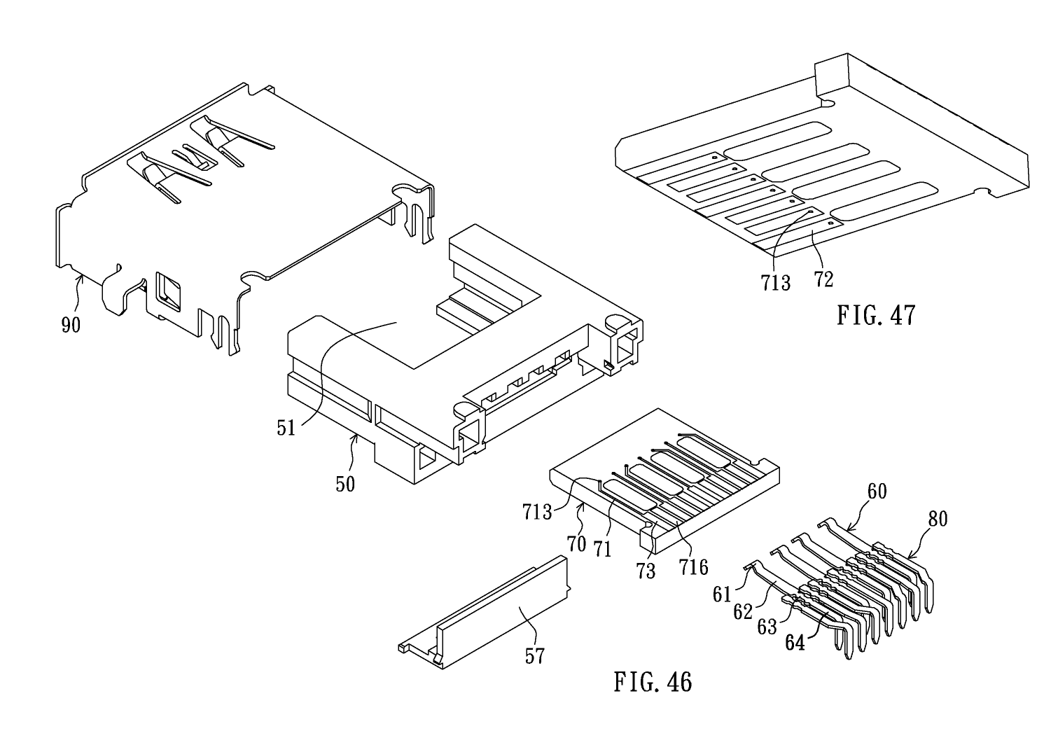

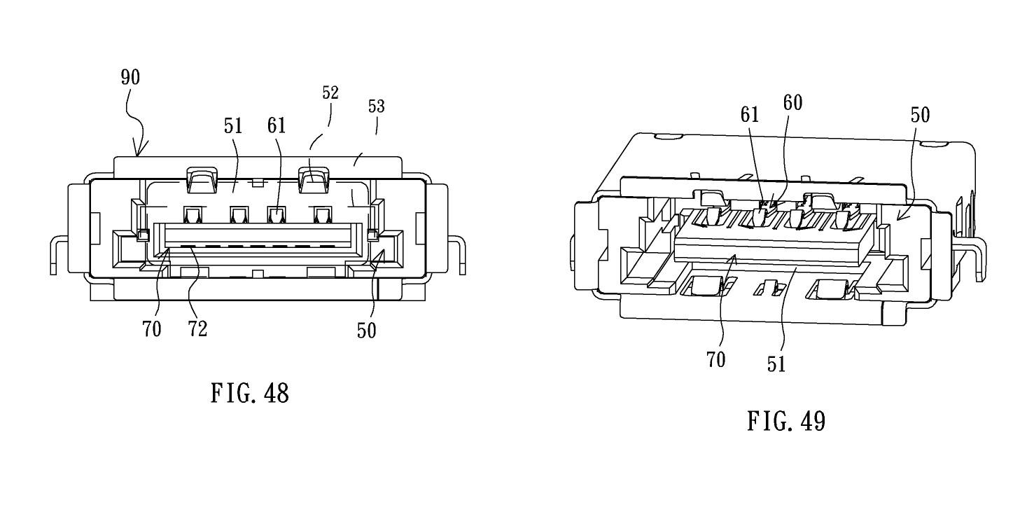

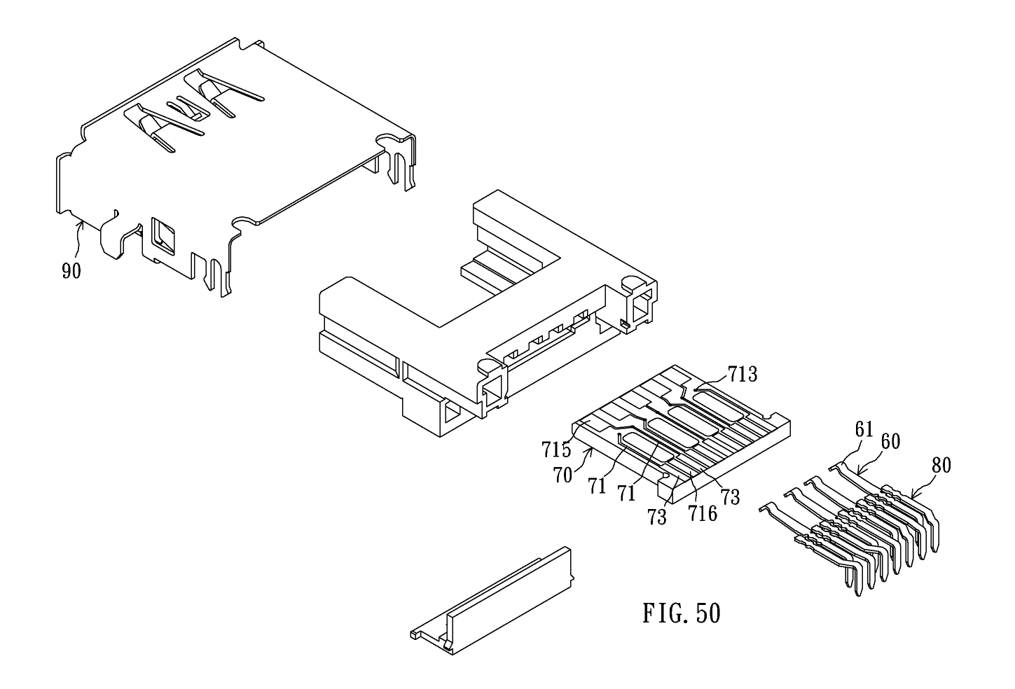

As shown in FIGS. 46 to 49, the 21^{st} embodiment of the invention is almost the same as the twentieth embodiment except that the one row of seven first connection points 72 of this embodiment are separately arranged on the bottom surface of the front section of the circuit board 70. Each first connection point 72 passes to the top surface of the front section of the circuit board 70 through a via 713 and is electrically connected to a first trace 71.

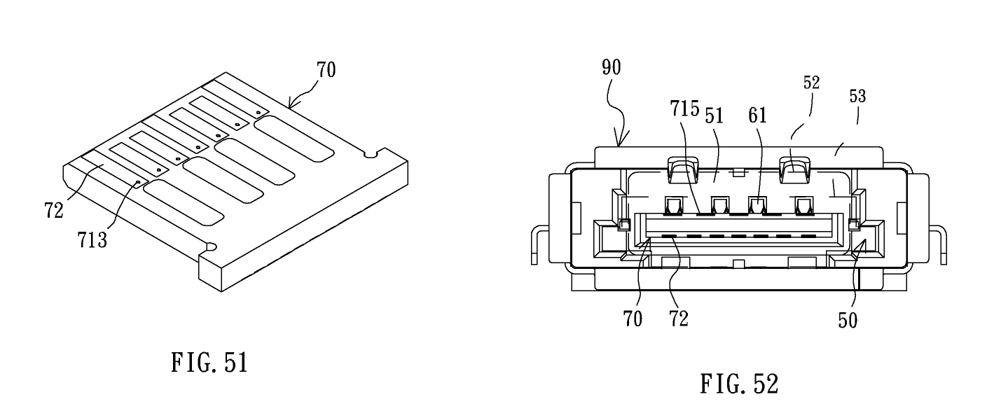

As shown in FIGS. 50 to 52, the 22^{nd} embodiment of the invention is a common socket for a USB 3.0 plug and an eSATA plug and is almost the same as the 21^{st} embodiment except that the top surface of the front section of the circuit board 70 of this embodiment is further formed with five third connection points 715 separately arranged. The third connection points 715 are respectively electrically connected to the first traces 71. The one row of third connection points 715 and the contacts 61 of the one row of connection terminals 60 form the USB 3.0 interface that may be electrically connected to a USB 3.0 plug. The third connection points 715 and the first connection points 72 are respectively electrically connected to the second connection points 73 through the first traces 71, so the pin terminals 80 are shared by both of them.

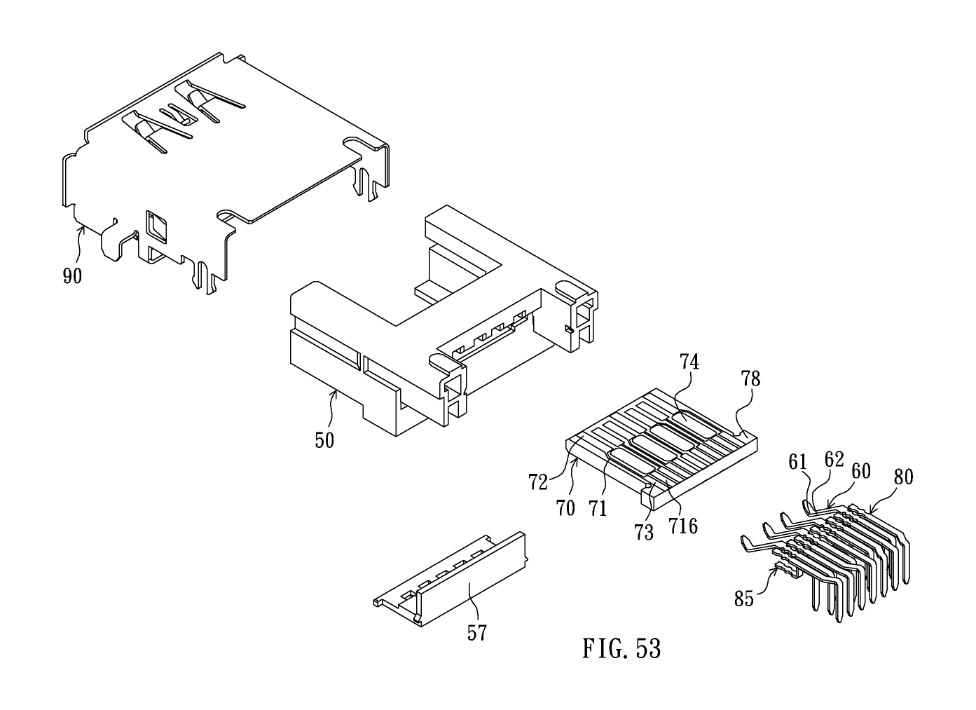

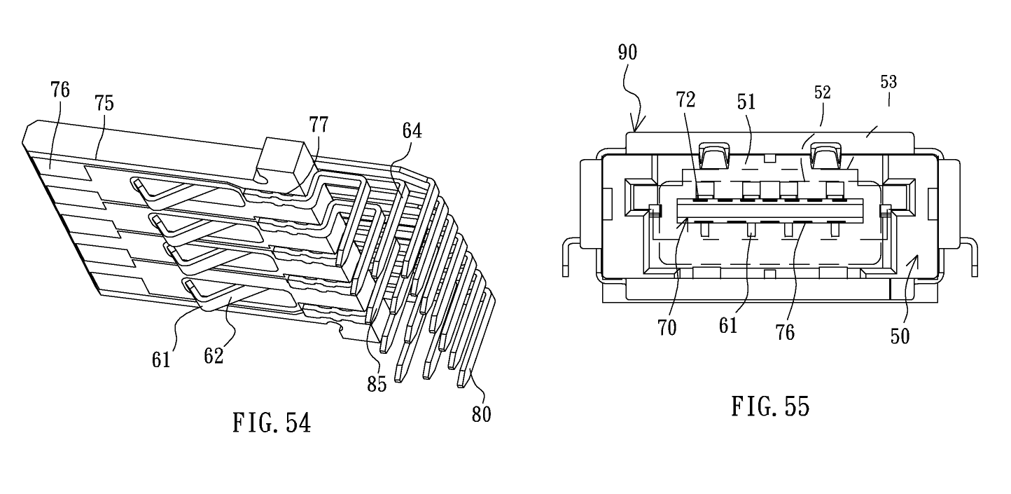

As shown in FIGS. 53 to 55, the 23^{rd} embodiment of the invention is a common socket of a USB 3.0 plug and an eSATA plug and is almost the same as the twentieth embodiment except that the bottom surface of the circuit board 70 of this embodiment is further formed with five second traces 75. Each second trace 75 has a first connection point 76 on one surface of the front section of the circuit board 70, and a second connection point 77 on the surface of the rear section of the circuit board 70. In addition, one row of five pin terminals 85 is provided. The pin terminal 85 is bonded to the second connection point 77. Similarly, the row of pin terminals 80 and the fixing portions 63 of the row of connection terminals 60 are also bonded to the second connection point 73 and the bonding pads 716 on the top surface of the circuit board 70. However, the extensions 62 of the one row of connection terminals 60 extend downwardly from the through slots 74 such that the contacts 61 project beyond the bottom surface of the circuit board 70. The first connection points 76 of the row of second traces and the contacts 61 of the row of connection terminals 60 form the USB 3.0 interface to be electrically connected to a USB 3.0 plug.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. A socket structure, comprising:
a plastic base;
a connection slot that may be connected to an inserted plug;
a circuit board, which is positioned on the plastic base and disposed in the connection slot and has a plurality of first traces, wherein the first traces have first connection points on one surface of a front section of the circuit board, and second connection points on a rear section of the circuit board, and the first connection points are electrically connected to the plug; and
a plurality of pin terminals electrically connected to the second connection points of the first traces and having first ends extending out of the plastic base.

2. The socket structure according to claim 1, further comprising one row of connection terminals separately arranged in the connection slot, wherein each of the connection terminal has a contact, an extension, a fixing portion and a pin, and the contact projects beyond one surface of the circuit board and may be elastically moved.

3. The socket structure according to claim 2, wherein the circuit board has a plurality of separately arranged through slots extending from front to rear, and the contacts of the connection terminals may be elastically moved in the through slots.

4. The socket structure according to claim 1, wherein the circuit board further has a plurality of second traces, the second traces have first connection points on the other surface of the front section of the circuit board, and the second traces are electrically connected to the first traces.

5. The socket structure according to claim 4, wherein the second traces have second connection points on the rear section of the circuit board, and the second connection points of the second traces are electrically connected to the second connection points of the first traces.

6. The socket structure according to claim 1, wherein the circuit board further has a plurality of second traces, the second traces have first connection points on the other surface of the front section of the circuit board, and second connection points on the rear section of the circuit board, and the second connection points of the second traces are electrically connected to the pin terminals.

7. The socket structure according to claim 1, wherein the circuit board further has a plurality of second traces, the second traces have first connection points on the other surface of the front section of the circuit board and second connection points on the rear section of the rear section of the circuit board, and the circuit board further has a plurality of pin terminals electrically connected to the second connection points of the second traces.

8. The socket structure according to claim 2, wherein the connection slot has a first slot and a second slot, which have different widths or heights and can be engaged with plugs with different widths or heights, and the first slot and the second slot share a common chamber.

9. The socket structure according to claim 8, wherein the height of the second slot is smaller than the height of the first slot, the width of the second slot is greater than the width of the first slot, the first slot can be engaged with a USB plug, and the second slot may be engaged with an eSATA plug.

10. The socket structure according to claim 1, further comprising a metal casing covering the plastic base, wherein one surface of the metal casing is formed with an opening from which the connection slot is exposed.

11. The socket structure according to claim 1, wherein a rear end of the plastic base is formed with separately arranged slots, one end of the pin terminal is formed with a fixing portion, a middle of the fixing portion is formed with a projection projecting beyond a plate surface of the fixing portion, the fixing portion of the pin terminal is engaged with the slot of the plastic base, and the projection is electrically connected to the second connection point of the first trace.

12. The socket structure according to claim 1, wherein one end of the pin terminal is formed with a fixing portion bonded to the second connection point of the first trace.

13. The socket structure according to claim 5, wherein the second connection point of the first trace, the second connection point of the second trace are electrically connected to a via, the via penetrates through the rear section of the circuit board, an inner wall of the via is formed with a metal layer, and the pin terminal is inserted into the via for electrical connection.

14. The socket structure according to claim 6, wherein a rear end of the plastic base is formed with separately arranged slots, one end of the pin terminal is formed with a fixing portion, a middle of the fixing portion is formed with a projection projecting beyond a plate surface of the fixing portion, the fixing portion is formed with an elastic sheet on a bottom side, the fixing portion of the pin terminal is engaged with the slot of the plastic base, the projection is electrically connected to the second connection point of the first trace, and the elastic sheet is in elastic contact with the second connection point of the second trace.

15. The socket structure according to claim 2, wherein the fixing portion of the connection terminal is fixed to the plastic base.

16. The socket structure according to claim 2, wherein the fixing portion of the connection terminal is fixed to the circuit board.

17. The socket structure according to claim 1, wherein the connection slot is integrally formed on the plastic base.

18. The socket structure according to claim 10, wherein the connection slot is formed by the metal casing.

19. The socket structure according to claim 7 being a display port socket, wherein two sides of the circuit board are formed with downward projections, a top surface of the circuit board is formed with the first traces having the number of ten, a bottom surface of the circuit board is formed with the second traces having the number of ten, and a bottom end of one side of the connection slot is narrower than a top end of the one side of the connection slot so that an inclined surface is formed.

20. The socket structure according to claim 7 being a HDMI socket, wherein bottom ends of two sides of the circuit board are narrower than top ends of the two sides of the circuit board so that two inclined surfaces are formed, a top surface of the circuit board is formed with the first traces having the number of ten, a bottom surface of the circuit board is formed with the second traces having the number of nine, and bottom ends of two sides of the connection slot are narrower than top ends of the two sides of the connection slot so that two inclined surfaces are formed.

21. The socket structure according to claim 7 being a socket shared by a display port and an HDMI, wherein two sides of the circuit board are not formed with downward projections, a top surface of the circuit board is formed with the first traces having the number of ten, a bottom surface of the circuit board is formed with the second traces having the number equal to ten, and a bottom end of only one side of the connection slot is narrower than a top end of the only one side of the connection slot so that an inclined surface is formed.

22. The socket structure according to claim 21, wherein the top surface of the circuit board is formed with ten connection points electrically connected to the ten second traces on the bottom surface of the circuit board, and the number of the pin terminals is equal to 39, wherein 20 of the pin terminals are electrically connected to the second connection points of the ten first traces and the ten connection points on the top surface of the circuit board, the bottom surface of the circuit board is formed with ten connection points electrically connected to the ten first traces on the top surface of the circuit board, and the other 19 pin terminals are respectively electrically connected to the second connection points of the nine second traces and the ten connection points on the bottom surface of circuit board.

23. The socket structure according to claim 22, wherein the first connection point of one of the second trace, which is disposed on the one side of the circuit board and is not shared, projects beyond a front end of the circuit board by a higher extent than the first connection points of the other second traces.

24. The socket structure according to claim 10, wherein the plastic base forms two sides of the connection slot, and the metal casing forms top and bottom surfaces of the connection slot.

25. The socket structure according to claim 2, wherein the contact of the connection terminal projects from a plate surface of the extension, and one end of the contact is connected to the extension and gradually projects and extends to an open end from front to rear.

26. The socket structure according to claim 2, wherein the fixing portions of the connection terminals and fixing portions of the pin terminals are located on the same surface of the circuit board.

27. The socket structure according to claim 26, wherein the fixing portions of the one row of connection terminals and the fixing portions of the one row of pin terminals are arranged in a row and located on the same height.

28. The socket structure according to claim 2, wherein the front section of the circuit board is further formed with one row of third connection points, the third connection points and the first connection points of the first traces are located on the same surface, the third connection points are respectively electrically connected to the first traces, and the contacts of the connection terminals project beyond the one surface of the circuit board formed with the third connection points.

29. The socket structure according to claim 2, wherein the front section of the circuit board is further formed with one row of pin terminals and one row of third connection points, the pin terminals of the third connection points and the first connection points of the first traces are disposed on the same surface, the other surface of the circuit board is formed with second traces and second connection points, each of the second connection points is disposed at a rear end of the circuit board and is electrically connected to one of the second traces, the pin terminals are bonded to the second connection points, and each of the second traces is electrically connected to one of the third connection points.
